(19) United States
(12) Patent Application Publication
(10) Pub. No.: US 2009/0144029 A1
(43) Pub. Date: Jun. 4, 2009

(54) SYSTEM AND METHOD OF PROVIDING CODE COMPLIANT WALL BRACING

(75) Inventors: Christopher W. Brandt, Boise, ID (US); Mathew-Joseph C. O'Connor, Meridian, ID (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/948,870

(22) Filed: Nov. 30, 2007

(51) Int. Cl. G06F 17/50

(52) U.S. Cl. 703/1

(57) ABSTRACT

Aspects of the present invention are directed at determining whether a structure's braced wall layout complies with building code bracing requirements. In accordance with one embodiment, a method is provided that obtains input describing the geometry of the braced wall line. Then, the applicable building codes that define the wall bracing requirements for the structure are identified. Each bracing member in the braced wall line is selected and processed so that the method may compile data that identifies the location of each bracing member and quantifies the bracing provided in the aggregate. Then, a determination may be made regarding whether the aggregate amount and location of bracing that is provided is a sufficient to satisfy the applicable building codes.

### FIELD OF THE INVENTION

The present invention relates generally to computer software that models components of a structure.

### BACKGROUND OF THE INVENTION

In the construction of buildings such as houses and apartment units, there are numerous techniques for laterally bracing wall segments. In this regard, wall segments are generally comprised of wooden frames formed of upright studs that are parallel to each other and separated by a predetermined distance. Wall bracing is an important element of a structure, providing resistance to forces that act along the wall plane. For example, braced wall lines add resistance to in-plane lateral forces such as wind and earthquake forces. In this regard, there are a multitude of products in the market utilized by building contractors and others for bracing walls against in-plane lateral forces (hereinafter referred to as “external forces”).

Those skilled in the art will recognize that braced wall panels are those areas of a framed wall that contain let-in bracing, diagonal board sheathing, or other code-approved sheet material to stiffen the structure against external forces. For example, FIG. 1 depicts a framed wall 100 that consists of a plurality of upright studs 102, 104, 106, 108, and 110. In this example, the diagonal bracing member 112 connects to the upright studs 102-110 to brace the framed wall 100 against external forces. Those skilled in the art and others will recognize that, braced wall panels such as the framed wall 100, may be pre-fabricated. In this instance, the braced wall panel may contain proprietary pre-fabricated wall bracing products that add resistance to external forces.

Increasingly, building codes such as the International Residential Code (“IRC”) and International Building Code (“IBC”) are being used by government entities to define building requirements in various jurisdictions. By way of example only, Section 602.10 of the IRC defines methods for bracing walls, the requirements and limitations of which may depend on a number of factors. In this regard, the extent a wall line is required to be braced under this section of the IRC depends on the wall length, wall location (interior or exterior wall), number of stories in the structure, the types of materials being used, and the like. Moreover, IRC requirements may vary depending on the geographic location. For example, the IRC may impose more stringent wall bracing requirements for storm-prone coastal regions or regions with more significant seismic activity than other areas.

Traditionally, determining whether a braced wall layout complies with code bracing requirements has largely consisted of performing a set of labor-intensive tasks. For example, a user may have to compare the attributes of each wall in a structure with various code sections and tables in the IRC. Since the IRC defines a variety of methods for satisfying bracing requirements, performing this comparison is time-consuming and error-prone. Moreover, additional labor-intensive tasks would have to be performed to identify a braced wall layout that both minimizes costs and complies with code requirements.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at determining whether a structure's braced wall layout complies with building code bracing requirements. In accordance with one embodiment, a method is provided that obtains input describing the geometry of the braced wall line. Then, the applicable building codes that define the wall bracing requirements for the structure are identified. Each bracing member in the braced wall line is selected and processed so that the method may compile data that identifies the location of each bracing member and quantifies the bracing provided in the aggregate. Then, a determination may be made regarding whether the aggregate amount and location of bracing that is provided is sufficient to satisfy the applicable building codes.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts a framed wall with diagonal bracing members that brace the framed wall against external forces in accordance with the prior art;

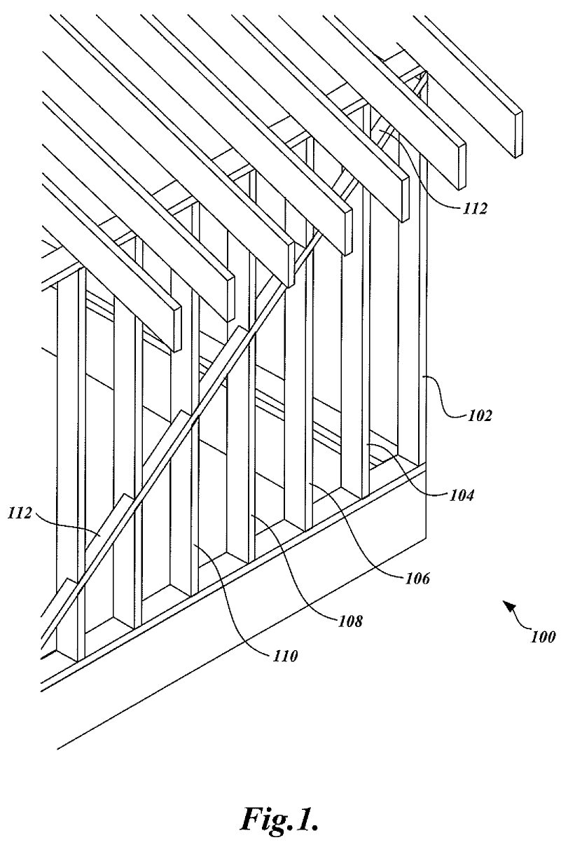

FIG. 2 depicts components of a computer that may be used to implement aspects of the present invention;

FIG. 3 is a flow diagram of an illustrative routine for determining whether a braced wall layout complies with code requirements in accordance with one embodiment of the present invention; and

FIG. 4 depicts an exemplary selection user interface that may be used to illustrate aspects of the present invention.

### DETAILED DESCRIPTION

Prior to discussing the details of the invention, it should be understood that the following description is presented largely in terms of logic and operations that may be performed by conventional computer components. These computer components, which may be grouped in a single location or distributed over a wide area, generally include computer processors, memory storage devices, display devices, input devices, etc. In circumstances where the computer components are distributed, the computer components are accessible to each other via network communication links. For example, aspects of the present invention may be implemented in a network environment such as the Internet, an intranet network, a wide area network (WAN), a local area network (LAN), and the like. While aspects of the invention may be described in terms of programs or processes executed by these computer components, those skilled in the art and others will recognize that those aspects also may be implemented in combination with other program modules. Generally described, program modules include routines, subroutines, programs, processes, components, data structures, functions, interfaces, objects, etc., which perform particular tasks or implement particular abstract data types.

As used herein the term “wall segment” generally refers to a section of a framed wall in which wall bracing may or may not be provided depending on requirements of the building code. A “braced wall panel” is a discrete unit within a wall segment that is braced using proprietary or other bracing material allowed by the building codes. Moreover, a “braced wall line” is a collection of one or more wall segments and/or openings in which braced wall panels are provided at required locations. A “braced wall layout” generally refers to a wall bracing schema that describes the geometry of various braced wall panels in a structure.

Although the invention will be described primarily in the context of software for determining whether a braced wall layout complies with bracing requirements defined in the applicable building code, those skilled in the art and others will appreciate that the present invention is also applicable in other contexts. In any event, the following description first provides a general overview of a computer system suitable for implementing aspects of the present invention. Then a routine that performs processing to determine whether a braced wall layout complies with code bracing requirements is described. The examples provided herein are not intended to be exhaustive or to limit the invention to the precise forms disclosed. Similarly, any steps described herein may be interchangeable with other steps or combinations of steps in order to achieve the same result. Accordingly, the embodiments of the present invention described below should be construed as illustrative in nature and not limiting.

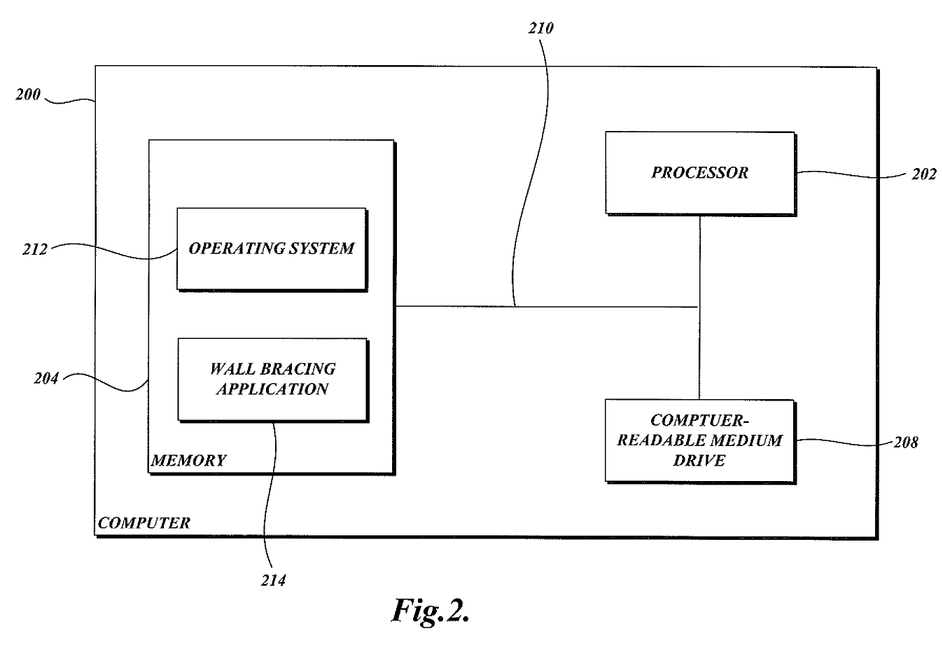

Now with reference to FIG. 2, an exemplary computer 200 with components that are capable of implementing aspects of the present invention will be described. Those skilled in the art and others will recognize that the computer 200 may be any one of a variety of devices including, but not limited to, personal computing devices, server-based computing devices, mini and mainframe computers, laptops, or other electronic devices having some type of memory. For ease of illustration and because it is not important for an understanding of the present invention, FIG. 2 does not show the typical components of many computers, such as a keyboard, a mouse, a printer, a display, etc. However, the computer 200 depicted in FIG. 2 includes a processor 202, a memory 204, a computer-readable medium drive 208 (e.g., disk drive, a hard drive, CD-ROM/DVD-ROM, etc.), that are all communicatively connected by a communication bus 210. The memory 204 generally comprises Random Access Memory (“RAM”), Read-Only Memory (“ROM”), flash memory, and the like.

As illustrated in FIG. 2, the memory 204 stores an operating system 212 for controlling the general operation of the computer 200. The operating system 212 may be a general purpose operating system, such as a Microsoft® operating system, a Linux® operating system, or a UNIX® operating system. Alternatively, the operating system 212 may be a special purpose operating system designed for non-generic hardware. In any event, those skilled in the art and others will recognize that the operating system 212 controls the operation of the computer 200 by, among other things, managing access to the hardware resources and input devices. For example, the operating system 212 performs functions that allow a program to read data from the computer-readable media drive 208.

As further depicted in FIG. 2, the memory 204 additionally stores program code and data that provides a wall bracing application 214. In one embodiment, the wall bracing application 214 comprises computer-executable instructions that, when executed by the processor 202, implements functionality to determine whether the location and amount of bracing in a braced wall layout complies with code bracing requirements, among other functionalities. In one embodiment, the wall bracing application 214 includes a user interface suitable for obtaining input that describes the physical parameters of a braced wall line. The data input into the user interface may include project specific information such as, but not limited to, wall geometry (height, length, opening sizes, offsets, etc.), wall location (interior or exterior wall), number of stories in the structure, type of desired bracing, and the like. Moreover, from the user interface, the seismic/wind design category for the structure may be input. Based on this input, the wall bracing application 214 identifies the code sections that define the bracing requirements for the structure. Then, the wall bracing application 214 steps through these requirements to identify a braced wall layout in which the location and amount of bracing complies with the code requirements. In this regard, output may be generated indicating whether a braced wall layout for a wall line may be generated that complies with the applicable code requirements. Moreover, the output may contain data that describes the attributes of a braced wall layout for a wall line in which the location and type of wall bracing provided would satisfy code. As a result, the wall bracing application 214 allows a user to quickly identify a code compliant wall bracing solution without having explicit knowledge of the bracing requirements imposed by the building code.

A specific computer configuration and software components have been described with reference to FIG. 2. However, those skilled in the art and others will recognize that aspects of the present invention may be implemented in other contexts than those depicted in FIG. 2. For example, the invention may be implemented in a Web or other network environment in which the wall bracing application 214 is executed on one or more remote computers. Thus, the illustrative embodiment and specific computer configuration illustrated in FIG. 2 should be construed as exemplary.

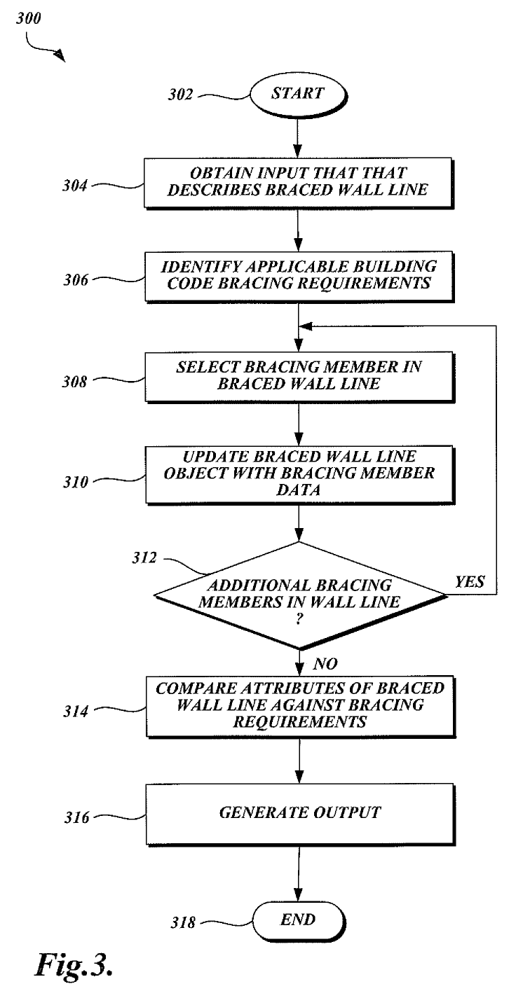

Now with reference to FIG. 3, an exemplary compliance routine 300 that may be used to determine whether a braced wall layout complies with code bracing requirements will be described. As illustrated in FIG. 3, the compliance routine 300 begins at block 302, and at block 304, input that describes a braced wall line is obtained. In this regard, the input obtained at block 304 may include, but is not limited to, data that describes wall geometry (height, length, opening sizes, offsets, etc.), wall location (interior or exterior wall), number of stories in the structure, desired bracing type, and the like. Moreover, the input obtained at block 304 may also include job category and year information used to identify applicable code sections. In accordance with one embodiment, the data input at block 302 may be input from a graphical user interface (“GUI”) such as the user interface 400, described below.

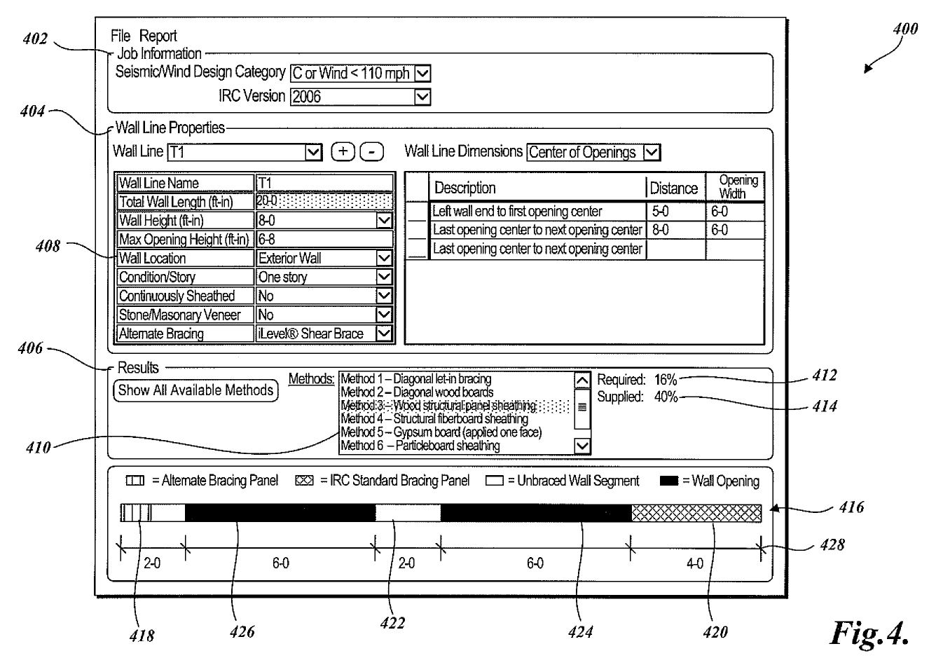

For illustrative purposes and by way of example only, an exemplary selection user interface 400 suitable to obtain input from a user that describes a braced wall line is depicted in FIG. 4. In accordance with one embodiment, the selection user interface 400 is a GUI with readily understandable controls, such as icons, scroll bars, buttons, links, menus, etc. In this exemplary embodiment, controls for interacting with the user are included in a job information region 402, wall line properties region 404, and the results region 406.

As further illustrated in FIG. 4, the selection user interface 400 includes a plurality of user interface controls commonly known as drop-down menus. In this regard, drop-down menus in the job information region 402 allow a user to identify the seismic/wind design category for a structure. Also, a control in the job information region 402 allows the user to identify an appropriate building code and year that should be applied for the structure. Similarly, the wall line properties region 404 includes drop-down menus for providing input that describes the attributes of a particular braced wall line. For example, by interacting with the wall location drop-down menu 408, the user may identify whether the selected wall line is an interior or exterior wall. Additional user interface controls in the “description” field in the wall line properties region 404 allow the user to identify locations in a wall line where openings for windows, doors, and the like are located.

As further illustrated in FIG. 4, the results region 406 in the selection user interface 400 includes a menu 410 that identifies a number of different bracing methods that may be used to satisfy bracing requirements. By interacting with the menu 410, the user may identify a preferred bracing method such as let-in bracing, diagonal bracing, sheathing, etc. Aspects of the present invention process the data input into the selection user interface 400 to determine whether a braced wall layout for the braced wall line described in data input by the user may be generated that satisfies code requirements. As described in further detail below, output that describes the results of this processing may also be presented on the selection user interface 400.

In one embodiment, input that describes the attributes of one or more braced wall lines may be obtained programmatically, at block 304 (FIG. 3), without utilizing a GUI. For example, aspects of the present invention may be integrated into another computer program that allows a user to identify attributes for an entire structure. In this instance, attributes of the structure may have previously been input or otherwise obtained from the user. Accordingly, obtaining input that describes a braced wall line, at block 304, may occur programmatically by, for example, accessing a database that stores the attributes of a structure.

As further illustrated in FIG. 3, at block 306, the appropriate building code sections that define the applicable wall bracing requirements for a structure are identified. As described previously, the seismic/wind design category for the structure and the applicable building code year may be input via a user interface provided by the present invention. In one embodiment, the design category, building code, and year are used to identify the applicable wall bracing requirements for the structure. More specifically and by way of example only, various subsections, definitions, tables, and the like in Section 602.10 of the IRC may be applied to define the wall bracing requirements for the various design categories of structures. In one embodiment, the appropriate wall bracing requirements are identified, at block 306, by performing a lookup in the IRC using a structure's design category and/or geometry data as the search keys.

As further illustrated in FIG. 3, a bracing member in the braced wall line being analyzed is selected, at block 308. Generally described, the present invention is directed at identifying a braced wall layout that complies with code mandated bracing requirements. In order to make this determination, attributes of the wall bracing members in the braced wall line are compiled to identify an aggregate amount and location of bracing in the braced wall line. In this regard, the compliance routine 300 implements an iterative process in which bracing members in the braced wall line are successively selected and processed. In one embodiment, bracing members are selected based on location or proximity of a member to an edge in the braced wall line with the bracing member that is closest to the edge being selected first. On subsequent iterations, bracing members are selected and processed based on the proximity to other bracing members. In an alternative embodiment, bracing members are selected starting from the centermost member and moving outward to members that are closer to the edges in the braced wall line. In yet another alternative embodiment, bracing members are selected starting at a particular edge with subsequent members being selected in order across the wall line. In any event, a bracing member is selected, at block 308, so that a determination may be made regarding whether the aggregate amount and location of bracing in a braced wall line is sufficient to comply with code requirements.

At block 310, a braced wall line object is updated with data that describes attributes of the selected bracing member. Those skilled in the art and others will recognize that high level programming languages are “object oriented” in that functionality of a program may be implemented in objects created from a class. As a program executes, the braced wall line object that contains data items describing bracing members in the braced wall line is updated with data that describes each bracing member that is selected at block 308. As mentioned previously, by compiling data that describes attributes of these individual bracing members, the total amount of aggregate bracing for the braced wall line and the their locations may be identified.

As further illustrated in FIG. 3, at block 312, a determination is made regarding whether additional bracing members in a braced wall line will be selected. As mentioned previously and in accordance with one embodiment, bracing members in a braced wall line are first selected based on proximity to an edge of the wall line. Thus, if the bracing member that is closest to the other edge of the braced wall line has not been previously selected, then the compliance routine 300 proceeds back to block 308 and blocks 308-312 repeat until all of the bracing members in the braced wall line have been selected. Conversely, if all of the bracing members in the braced wall line have been previously selected, then the compliance routine 300 proceeds to block 314.

At block 314, the compliance routine 300 compares the attributes of the braced wall line against the bracing requirements as defined the applicable code sections. When block 314 is reached, the building codes that define the applicable wall bracing requirements have been identified (at block 306). Moreover, data that describes the bracing provided by individual bracing members in a braced wall line and their locations has been compiled (at block 310). Once this data is available, a comparison may be performed to determine whether a braced wall line complies with bracing requirements as defined in the applicable code sections. For example, if the total amount of bracing provided by a braced wall line exceeds the total amount of bracing required by the applicable code sections and all other bracing requirements defined in the code are satisfied, an internal data item may be set to indicate that the braced wall line is in compliance with the code. On the other hand, if the total amount of bracing in the braced wall line is below the required amount, an internal data item is set to indicate that the braced wall line does not satisfy the code bracing requirements. Those skilled in the art and others will recognize the error handling may be performed in instances when a user provides invalid input. For example, when a user provides input describing a braced wall line that cannot comply with building codes, one or more error messages may be displayed that describe the type of error that was encountered.

As further illustrated in FIG. 3, at block 316, the compliance routine 300 generates output that indicates whether a braced wall line complies with code bracing requirements. In one embodiment, the output is displayed to the user on the selection user interface 400 (FIG. 4). In this regard, the compliance routine 300 may issue a call at block 316 to refresh data that is displayed to the user on the selection user interface 400.

With reference again to FIG. 4, additional aspects of the selection user interface 400 provided by aspects of the present invention will be described. In this regard, the selection user interface 400 includes exemplary output that may be displayed by the compliance routine 300. In this regard, the results region 406 of the selection user interface 400 includes a bracing required entry 412 and a bracing supplied entry 414. The bracing required entry 412 identifies the total amount (e.g., “16%”) of wall bracing required by the code for a particular braced wall line. Moreover, the bracing supplied entry 414 identifies the total aggregate bracing provided by the braced wall line (e.g., “40%”). The braced wall line depicted in FIG. 4 supplies a sufficient amount of wall bracing since the supplied amount is larger than the required amount.

As further illustrated in FIG. 4, the output produced on the selection user interface 400 may include a visual depiction of the wall bracing being provided in a braced wall layout. In this regard, the selection user interface 400 in FIG. 4 includes a graphical bracing diagram 416 that includes the alternative braced marker 418 and the standard braced marker 420. The area in the graphical bracing diagram 416 allocated to the braced markers 418 and 420 identify locations along the braced wall line where bracing is being provided. Similarly, the graphical bracing diagram 416 provides a bracing gap marker 422 and the opening markers 424 and 426. Finally, the selection user interface 400 depicted in FIG. 4 includes a distance indicator 428 that identifies the distances between the different segments of the braced wall line depicted in the graphical bracing diagram 416.

In one embodiment, the user may manipulate graphical components presented on the selection user interface 400 for the purpose of determining whether an alternative braced wall line complies with code requirements. In this regard, a user may employ an input device (e.g., mouse) to select one of the markers that designates areas in a braced wall line where bracing is being provided on the graphical bracing diagram 416. For example, the user may select the standard braced marker 420 and, using a technique known as drag-and-drop, remove the marker 420 from this braced wall line or relocate it to marker 422. In response, the compliance routine 300 performs processing to determine whether the new braced wall line, with changes made by the user, complies with code requirements. For example, if input is received that changes the composition of the bracing members in a braced wall line, the compliance routine 300 would proceed back to block 308. Then the iterative process implemented by the compliance routine 300 would determine whether the new braced wall layout complies with the applicable code requirements.

It should be well understood that the selection user interface 400 depicted in FIG. 4 should be construed as exemplary. In this regard, the selection user interface 400 depicts certain types of controls for interacting with the user. However, other types of controls and user interfaces may be used in conjunction with the present invention without departing from the scope of the claimed subject matter.

With reference again to FIG. 3, output produced by the compliance routine 300 at block 316 is stored in a database, event log, or other data store so that a report that describes the wall bracing in a structure may be produced. In other words, data that describes the wall bracing provided by braced wall lines in a structure may be compiled and summarized in a report. By reviewing the report, a builder or compliance officer may readily determine whether all of the braced wall lines in a structure comply with code requirements. Then, once the output is generated by the compliance routine 300, at block 316, it proceeds to block 318, where it terminates.

In another embodiment, the compliance routine 300 is configured to identify alternative braced wall lines for the user in order to achieve cost savings. For example, in the exemplary braced wall line described above with reference to FIG. 4, the amount of wall bracing required by the applicable code section is “16%” of the total wall length. However, the amount of bracing provided in the braced wall line is “40%.” Cost savings may be achieved by reducing the amount of wall bracing in this braced wall line. To this end, aspects of the present invention may be configured to implement an iterative process in which bracing members in a braced wall line are successively selected and removed from a braced wall line. Then, the compliance routine 300 is utilized to determine whether this alternative braced wall line complies with code requirements.

While the presently preferred embodiment of the invention has been illustrated and described, it will be readily appreciated by those skilled in the art and others that, within the scope of the appended claims, various changes can be made therein without departing from the spirit and scope of the invention.

The embodiments of the invention in which an exclusive property or privilege is claimed are defined as follows:

1. A computer-implemented method of determining whether a braced wall line in a structure complies with bracing requirements defined in a building code, the method comprising:
obtaining input that describes the geometry of the braced wall line;
identifying the applicable building codes that define the wall bracing requirements for the structure;
for each bracing member in the braced wall line, compiling data that identifies the location of the bracing member and quantifies the bracing provided by the bracing member into an aggregate for the braced wall line; and
determining whether the location of each bracing member and aggregate amount of bracing provided in the braced wall line is sufficient to satisfy the applicable building codes.

2. The method as recited in claim 1, further comprising generating output on a user interface that indicates whether the braced wall line complies with the applicable building codes.

3. The method as recited in claim 1, further comprising generating a report that summarizes the bracing provided by one or more braced wall lines in the structure.

4. The method as recited in claim 1, further comprising:
relocating a bracing member in the braced wall line to create an alternative braced wall line; and
determining whether the location of each bracing member and the aggregate amount of bracing provided in the alternative braced wall line is a sufficient to satisfy the applicable building codes.

5. The method as recited in claim 1, wherein the input that describes the geometry of the braced wall line includes proposed locations of bracing members provided by the user and wherein determining whether a braced wall line satisfies the applicable building codes includes determining whether the location of each proposed bracing member and aggregate amount of bracing as identified in the input received from the user is sufficient to satisfy the applicable building codes.

6. The method as recited in claim 1, wherein identifying the applicable building codes that define the wall bracing requirements for the structure includes identifying the structure's design category and performing a lookup using the design category as a search key.

7. The method as recited in claim 1, wherein compiling data that quantifies the bracing provided by the bracing member into an aggregate for the braced wall line includes sequentially selecting each bracing member using one selection technique from a group of selection techniques consisting of:
initially selecting a bracing member most proximate to an edge in the braced wall line then selecting subsequent bracing members based on proximity to the previously selected bracing member;
initially selecting the centermost bracing member then selecting subsequent bracing members based on proximity from the center of the braced wall line; and
initially selecting a bracing member that is the most proximate to an edge in the braced wall line then selecting subsequent bracing members in order across the braced wall line.

8. A user interface for accepting input and presenting output on a computer, the user interface operative to:
present controls that allow the user to provide input that identifies a design category and attributes of a braced wall line;
accept input that identifies a design category and attributes of the braced wall line including locations in the braced wall line where bracing members are located; and
generate output that indicates whether the braced wall line complies with code bracing requirements.

9. The user interface as recited in claim 8, wherein the input that describes attributes of a braced wall line includes at least one of the wall height, length, opening sizes, number of stories, and wall location.

10. The user interface as recited in claim 8, wherein the input that describes attributes of the braced wall line includes the type of bracing being employed for each bracing member in the braced wall line.

11. The user interface as recited in claim 8, wherein the output displayed to the user includes a visual representation of the braced wall line with selectable markers that represent bracing members and wherein the user interface is further configured to accept input to generate an alternative braced wall line.

12. The user interface as recited in claim 11, wherein the user interface is further configured to generate output that indicates whether the alternative braced wall line complies with code bracing requirements.

13. The user interface as recited in claim 8, wherein the output generated includes a comparison of the wall bracing required by the applicable code sections with the output supplied by the braced wall line.

14. A computer-readable medium having computer executable components for determining whether a braced wall line complies with bracing requirements defined in a building code, comprising:
a user interface component for accepting input that describes a wall geometry, wherein the input includes data that describes the location of bracing members in the braced wall line;
a compliance component operative to:
identify the applicable building codes that define the wall bracing requirements for the structure;
compile data that describes the location of each bracing member and identify the aggregate amount of bracing provided in the braced wall line; and
compare the amount and location of bracing in the braced wall line with the building codes to determine whether the bracing provided is sufficient.

15. The computer-readable medium as recited in claim 14, further comprising a reporting component configured to store compliance data in a data store and generate a report that summarizes the wall bracing provided by the braced wall lines in the structure.

16. The computer-readable medium as recited in claim 14, wherein the input accepted from the user interface component includes at least one of the wall height, length, opening sizes, number of stories, and wall location.

17. The computer-readable medium as recited in claim 14, wherein the input accepted from the user interface component includes the type of bracing being employed for each bracing member in the braced wall line.

18. The computer-readable medium as recited in claim 14, wherein the user interface component is further configured to present a visual representation of the braced wall line and accept input to relocate a bracing member from the braced wall line, and wherein the compliance component is further configured to determine whether the braced wall line as modified by the user complies with the building codes.

19. The computer-readable medium as recited in claim 14, wherein the compliance component is further configured to identify the structure's design category and perform a lookup using the design category as a search key.

20. The computer-readable medium as recited in claim 14, wherein the compliance component is further configured to remove a bracing member in the braced wall line to create an alternative braced wall line and determine whether the aggregate amount and location of bracing provided in the alternative braced wall line is a sufficient to satisfy the building code.
